(19) United States
(12) Patent Application Publication
(10) Pub. No.: US 2009/0189026 A1
(43) Pub. Date: Jul. 30, 2009

(54) CABLE SUPPORT MECHANISM AND METHOD OF USING SAME

(75) Inventor: William Bourgeois, San Diego, CA (US)

Correspondence Address: JERRY RICHARD POTTS, 3248 VIA RIBERA, ESCONDIDO, CA, 92029, US

(73) Assignee: Tek-Works, Inc., Poway, CA (US)

(21) Appl. No.: 12/020,087

(22) Filed: Jan. 25, 2008

(51) Int. Cl. F16L 3/08

(52) U.S. Cl. 248/70

(57) ABSTRACT

A cable support mechanism and cable support mechanism kit includes a U-shaped body member with a unitary construction having an elongate storage unit for housing at least one cable strap when such cable strap is not in use, an elongate cable strap securing unit for facilitating the positioning and securing of the cable strap in a locked position when such strap is in use for electrical conductor retaining and separating purposes, and an elongate cable saddle unit for supporting from below one or more electrical conductors within the cable support mechanism.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX”

Not Applicable

### BACKGROUND OF THE INVENTION

In home and office constructions, it is often necessary to add wiring for alarm and cable systems during and after the home and office constructions have been completed. Many such wiring situations require the retaining of multiple cables or strands of wire which need mounting in off floor groups where cable group weigh can be sufficiently heavy to cause lower or bottom group cables or wires to be flattened, or otherwise be sufficiently crushed so that their electrical integrity is impaired, degraded or evenly sufficiently comprised to break a required electrical connection. Therefore it would be highly desirable to have a new and improved apparatus and method of retaining groups of one or more cables in a fast and convenient manner off floor, while at the same time allowing for such groups of cables to be sufficiently separated within such an apparatus so that cable group weight exerted on bottom cables does not crush or otherwise impair the electrical integrity of the lower cables within such a grouping.

### BRIEF SUMMARY OF THE INVENTION

A cable support mechanism and cable support mechanism kit includes a U-shaped body member having an elongate storage unit for housing at least one cable strap when such cable strap is not in use, an elongate cable strap securing unit for facilitating the positioning and securing of said cable strap in a locked position when such strap is in use for cable retaining and separating purposes, and an elongate cable saddle unit for supporting from below one or more electrical conductors within the cable support mechanism.

### BRIEF DESCRIPTION OF THE DRAWINGS

FIG. 1 is a diagrammatic view of a cable support mechanism, which is constructed in accordance with an embodiment of the present invention;

FIG. 2 is a diagrammatic view of a cable strap being extracted from a storage position within an elongate cable storage unit forming part of the cable support mechanism of FIG. 1;

FIG. 3 is a side elevation view of an extracted cable strap being oriented into temporary locking engagement with an elongate cable strap securing unit forming part of the cable support mechanism of FIG. 1;

FIG. 4 is another side elevation view of an extracted cable strap being positioned into locking engagement within the elongate cable strap securing unit of FIG. 2;

FIG. 5 is a top plan view of the cable strap of FIG. 1;

FIG. 6 is a rear side elevational view of the cable support mechanism of FIG. 1;

FIG. 7 is a cross-sectional view of the cable support mechanism of FIG. 4;

FIG. 8 is a diagrammatic view of the cable support mechanism of FIG. 4, with a second cable strap positioned and locked in place in accordance with the present invention;

FIG. 9 is cut-away side elevation view of the cable support mechanism illustrating the unlocking and sliding placement of another cable strap within the cable strap securing unit of FIG. 4;

FIG. 10 is a diagrammatic illustration of a cable strap forming part of the cable support mechanism of FIG. 4;

FIG. 11 is a diagrammatic illustration of a cable support mechanism kit, which is constructed in accordance with the present invention.

### DETAILED DESCRIPTION OF THE PREFERRED EMBODIMENTS

The description that follows is presented to enable any person skilled in the art to make and use the invention. For purposes of explanation, specific nomenclature is set forth to provide a thorough understanding of the present invention. Descriptions of specific applications and methods are provided only as examples. Various modifications to the preferred embodiments will be readily apparent to those skilled in the art, and the general principles defined herein may be applied to other embodiments and applications without departing from the spirit and scope of the invention. Thus, the present invention is not intended to be limited to the embodiments shown, but is to be accorded the widest scope consistent with the principles and steps disclosed herein.

As will be explained hereinafter in greater detail, in one preferred embodiment a cable support mechanism is a hollow cable holder having a base leg member disposed between two upright straight leg members. One of the upright straight leg members has an elongated cutout for defining a pair of spaced apart integrally formed toothed wall members. Another one of the upright straight leg members has another elongated cutout disposed in parallel alignment with the first mentioned elongated cutout for cooperating therewith to define a cable strap path between the upright straight leg members of the cable support mechanism. The other mentioned one of the upright straight leg members has a pair of spaced apart integrally formed retaining slots wherein at least one cable strap is adapted to be slidably mounted between the retaining slots within this upright straight leg member. The cable strap is also adapted to be stored within this upright straight leg member when not in use clamping a cable and the cable strap is further adapted to be pulled upwardly a sufficient distance from within this straight leg members to enable the cable strap to be pivotally turned and extended to be received within the elongated cutout for rectilinear movement along the cable strap path. The cable strap has disposed on its distal end a pair of movable pawls for engaging the pair of spaced apart integrally formed toothed wall members for selectively locking the cable strap within the cable strap path to facilitate clamping a cable between the cable strap and the base leg member. Alternative, one group of cables may be support from below by the cable strap, while another group of cables may be supported from below by the base leg member. In this manner at least two groups of cables may be supported in the cable support mechanism. By adding additional cable straps as will be explained hereinafter in greater detail, additional cable groups may be supported from below by the additional cable straps.

In another preferred embodiment that will be explained hereinafter in greater detail, a cable support mechanism generally includes a body member having a unitary construction which has three leg where one leg is an elongate storage unit leg for housing at least one cable strap when such cable strap is not in use, where another leg is an elongate cable strap securing unit leg for facilitating the positioning and securing of the cable strap in a temporarily locked position when such strap is in use for electrical conductor retaining and separating purposes, and where a third leg is an elongate cable saddle unit leg for supporting from below one or more electrical conductors within the cable support mechanism.

In still yet another preferred embodiment, as will be explained hereinafter in greater detail, the cable support mechanism as described above is provided in a kit configuration with a plurality of cable support mechanisms and a plurality of cable straps, where the individual cable straps may be inserted and locked into place for cable supporting purposes as needed.

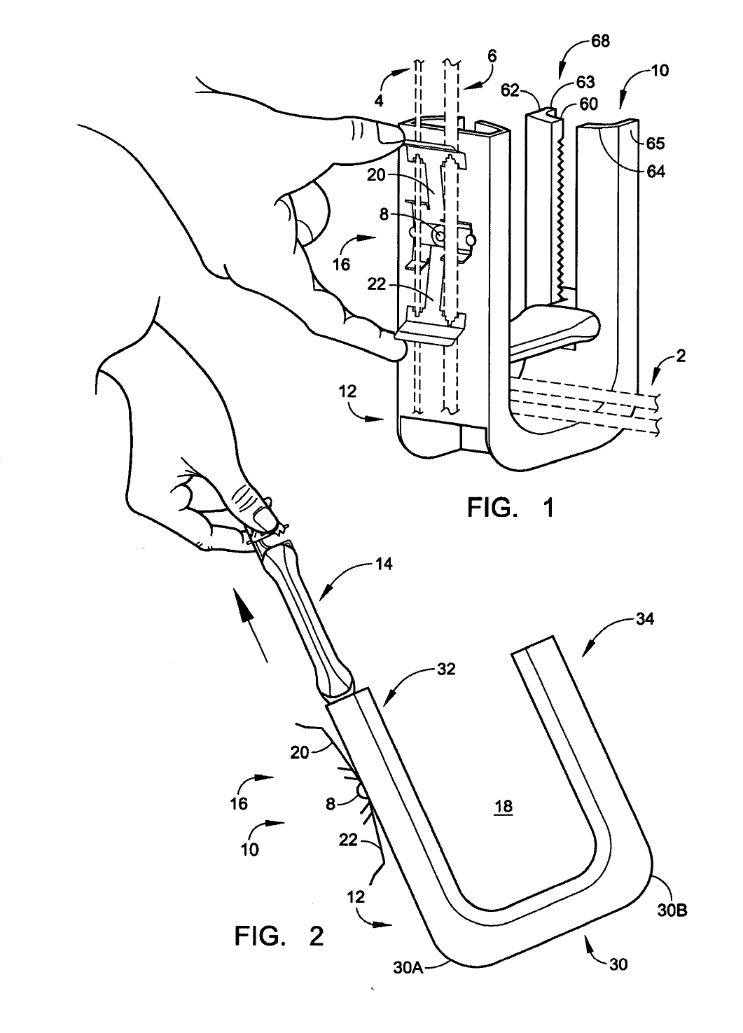

Referring now to the drawings and more particularly to FIGS. 1-2, there is illustrated a cable support mechanism 10 which is constructed in accordance with the present invention. The cable support mechanism 10 is adapted for supporting and separating one or more electrical conductor groups 2 and 2A as best seen in FIGS. 1 and 8. Because of its unique and novel structure, the cable support mechanism 10 functions to retain groups of multiple cables or wire strands in an off floor configuration without causing lower or bottom group cables or wires to be flattened, or otherwise crush due to load weighs. Moreover, its unique and novel structure allows for the retaining of multiple groups of one or more cables in a fast and convenient manner off floor, while at the same time allow for such groups of cables to be sufficiently separated within a single support device so that cable group weigh will not compromise the integrity of electrical connections or break electrical connections.

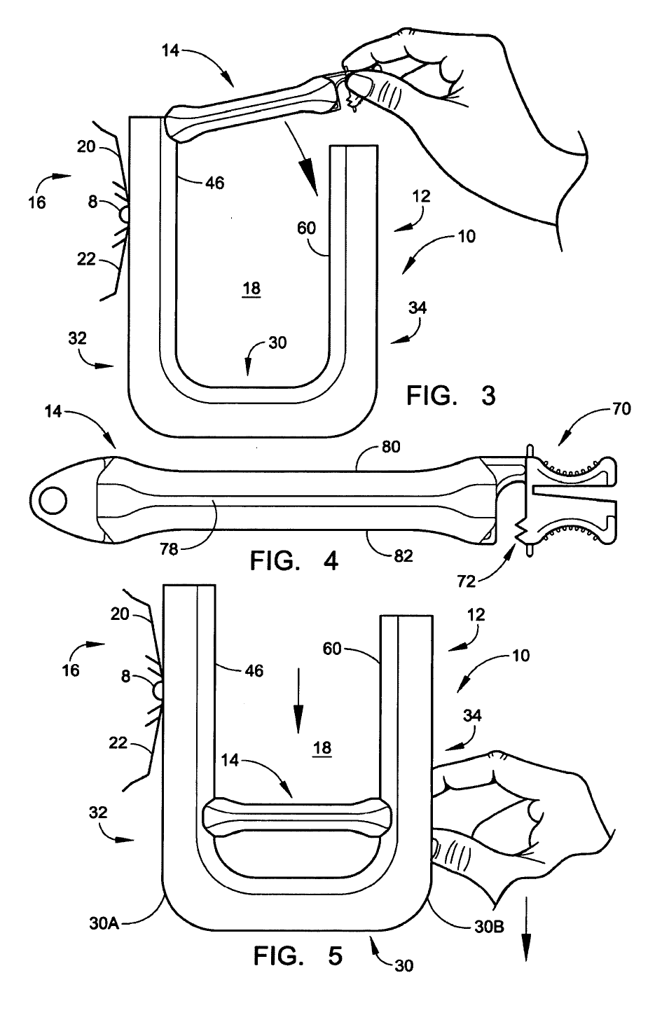

Considering now the cable support mechanism 10 in greater detail with reference to FIG. 1, the cable support mechanism 10 generally includes a body member 12 having a retaining clip 16 attached thereto to permit the body member 12 to be attached off floor. The body member 12 has a unitary construction and is configured in a U-shape when each leg of the body member 12 performs a different and unique function as will be explained hereinafter in greater detail. For the moment it will suffice to state that the body member 12 functions to store or house at least one cable strap 14 when such cable strap 14 is not in use, and further facilitates the extracting of the cable strap 14 from its storage position as best seen in FIG. 2 so that it may be rotated as best seen in FIG. 3 relative to its storage position and then slidably positioned in a fixed temporarily locked position as best seen in FIG. 4 for facilitating the mounting at least two groups of cables as best seen in FIG. 8. If only a single group of cables are to be supported and the single group does not have a sufficient weight factor to cause lower cables in such a group to be compromised by cable weight, the cable strap 14 may be extract and positioned above the cables to help retained the cables within the body member 12 as best seen in FIG. 1.

Considering now the off floor configuration of the cable support mechanism 10 in greater detail with reference to FIG. 1, the body member 12 as noted earlier is attached to a retaining clip 16 which permits the body member 12 to be attached off floor by affixing the retaining clip 16 to either a drop wire 4 or alternatively to a drop rod 6, which drop units are commonly utilized for supporting various items from structural components or ceilings. The retaining clip 16 is secured to the U-shaped body member 12 by suitable securing means, such as a rivet 8, which is affixed to one of the legs of the body member 12. The retaining clip 16, in turn, is adapted to be received on and secured to either the drop wire 4 or the drop rod 6. In this manner, the cable support mechanism 10 is supported in an upright position by either the drop wire 4 or drop rod 6 for retaining one or more cable groups, such as cable groups 2 and 2A off floor as best seen in FIG. 1.

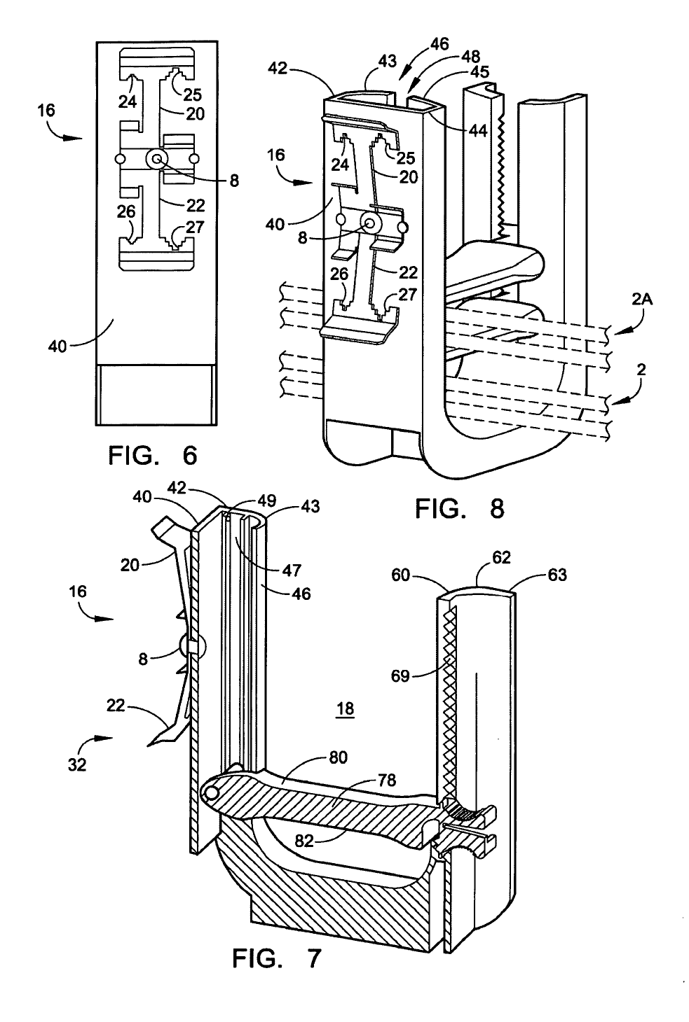

Considering now the retaining clip 16 in greater detail with reference to FIGS. 1 and 6, the retaining clip 16 generally includes an upper spring leg member 20 and a lower spring leg member 22 that are resilient and adapted to flex under finger force of a user and then when released to spring back to their respective resting positions. The upper spring leg members 20 includes a pair of spaced apart notch openings indicated generally at 24 and 25, while the lower spring leg member 22 includes another pair of spaced apart notch openings indicated generally at 26 and 27. Notch openings 24 and 26 are small notch openings suitable for receiving therein a drop wire, such as the drop wire 4, while notch openings 25 and 27 are large notch openings suitable for receiving therein a drop rod, such as the drop rod 6. Notch openings 24, 26 and 25, 27 respectively are in vertical alignment. In this regard, when the upper and lower spring leg members 20 and 22 are bent toward each other as best seen in FIG. 1, they help create a lateral notch opening for either the drop wire 4 or the drop rod 6 whichever the case maybe. Upon release of the spring legs by an installer, the legs snap back to their original upright positions, allowing the edges of the notch openings to bite into and grip the supporting wire or rod member whichever the case may be. To facilitate equal bending of the upper spring leg member 20 and the lower spring leg 22 toward each other, the rivet 8 is disposed or secured midway between the upper spring leg member 20 and the lower spring leg member 22 as best seen in FIG. 6.

Considering now the U-shaped body member 12 in greater detail with reference to FIGS. 1-4 and 11, the U-shaped body member 12 has a unitary construction and generally includes a central elongate saddle member or leg unit 30 for supporting from below one or more electrical conductors or cable groups, an elongate cable strap storage member or leg unit 32 for storing at least one cable strap 14, and an elongate cable strap securing member or leg unit 34 for facilitating the positioning and securing of the cable strap 14 in a locked position when the cable strap 14 is in use for cable retaining and separating purposes.

In order to assure that such electrical conductors or cable groups are not presented with any sharp edges by the cable support mechanism 10, the cable saddle unit 30, the cable strap storage unit 32 and the cable strap securing unit are each configured with a smooth convex curved surface. These convex surfaces cooperate with the cable strap 14 as will be explained in greater detail hereinafter, to accommodate and help maintain the natural gradual bend radius exhibited by most electrical conductors. To facilitate the cooperation between these units, the saddle member 30 is integrally connected and sandwiched between a pair of up-turned end portions indicated generally at 30A and 30B respectively, which end portions gradually slope in a convex shape along their outer surfaces to their respective distal ends. The up-turned end portions 30A and 30B, in turn, are integrally connect respectively to elongate leg portions, which leg portions are substantially perpendicular to the saddle unit 30. These elongate leg portions comprise the elongate cable strap storage unit 32 and the elongate cable strap securing unit 34 respectively. From the foregoing, it should be understood that the elongate portions 32 and 34 are each disposed perpendicular to the elongate saddle member 30 to help form a perfect U-shape configuration for cable supporting purposes.

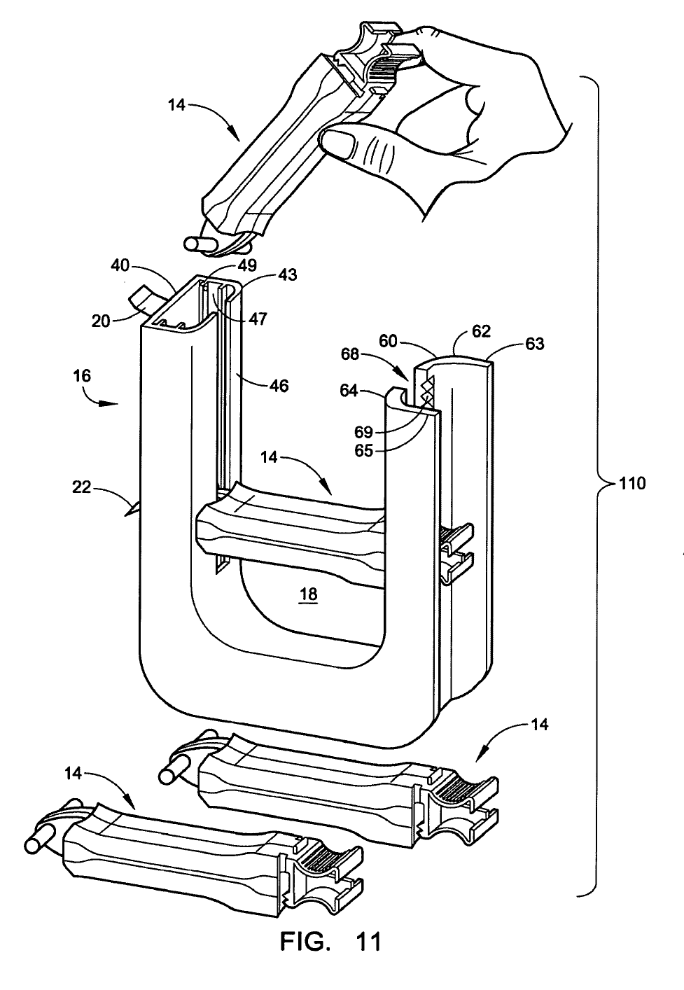

Considering now the cable strap storage unit 32 in greater detail with reference to FIGS. 1 and 7, the cable strap storage unit 32 is a hollow body member having an elongate back wall portion 40, elongate side wall portions 42 and 44 respectively, and an elongate front wall portion 46 which includes an elongate slot 48. The slot 48 extends downwardly, from the top of the front wall 46 or the top of the storage unit 32 to about the distal end of up-turned end portion 30A as best seen in FIG. 11. Elongate slot 48 is centrally disposed in the front wall portion 46 and extends along the longitudinal axis thereof. The wall portions of the cable strap storage unit 32 are configured in a cylinder like configuration with a sufficient volume which permits at least one cable strap, such as the cable strap 14 to be stored therein for easy retrieval when needed.

As best seen in FIGS. 7-8, the back wall portion 40, is disposed between laterally extending side wall portions 42 and 44 respectively. Laterally extending side wall portions 42 and 44 are generally perpendicular to the elongate back wall 40 and they extend inwardly toward a cable receiving area 18 of the cable support mechanism 10. Elongate front wall portion 46 is integrally connected to the side wall portions 42 and 44 respectively by elongated curved wall portions 43 and 45 respectively.

In order to help guide and retain the cable strap 14 within the cable strap storage unit 32 and relative to the cable strap securing unit 34, each of the elongate side wall portions 42 and 44 have inwardly disposed elongate cable strap tracks, such as a cable strap track 47. The cable strap tracks are disposed opposite one another and are spaced and dimensioned for receiving and guiding therein individual ones of a pair of cable strap stem members 50 and 51 respectively, as best seen in FIG. 10. The cable strap track 47 terminates at about the top or the distal end of the side wall 42, terminating in a stop indicated generally at 49. In this regard, when the cable strap 14 is pulled upwardly from its storage position within the cable strap storage unit 32, its upward motion is inhibited by the stops disposed in each of the tracks, such as the track stop 49 disposed at the distal end of strap track 47.

Considering now the elongate cable strap securing unit 34 in greater detail with reference to FIGS. 1 and 7, the cable strap securing unit 34, like the cable strap storage unit 32, is a plural wall structure that generally includes an elongate front wall portion 60 that is integrally connected by elongate curved wall portion 62 and 64 to elongate side wall portions 63 and 65 respectively. Front wall portion 60 includes an elongate slot 68 which is disposed in opposite alignment with elongate slot 48. In this regard, elongate slot 68 is centrally disposed on the longitudinal axis of the front wall portion 60 and extends downwardly from its top or distal end to about to the distal end of up-turned end portion 30B. As will be explained hereinafter in greater detail the slots 48, 68 are in horizontal and vertical alignment to function as a track for at least one cable strap, such as the cable strap 14, to be positioned in a locking position between the cable strap storage unit 32 and the cable strap securing unit 34.

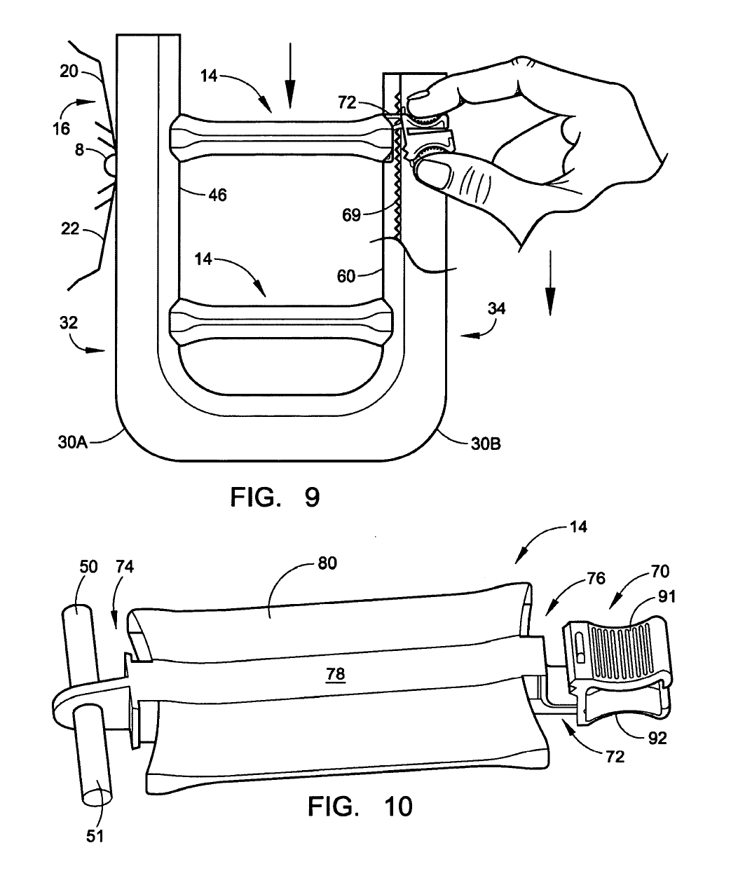

As best seen in FIGS. 1 and 7, the inner edge portions of elongate slot 68 is provided with a toothed structure 69 which is adapted to lockingly engage with a set of cable strap teeth indicated generally at 72. In this regard, the set of teeth 72 are disposed at about the distal end of the cable strap 14 on a finger engagable pinch lock 70. In use then, when the set of teeth 72 disposed on the cable strap 14, engage the toothed structure 69 of the elongate cable strap securing unit 34, the cable strap 14 is lockable in a plurality of different position along the cable strap securing unit elongate slot 68. In order to allow a user easy access for reaching finger engagable pinch lock 70 when it is positioned within the cable strap securing unit 34, the cable strap securing unit 34 is configured without a back wall as best seen in FIG. 7. Stated otherwise, the distance between the sidewalls 63 and 65 is sufficient to allow the user to grasp the pinch lock 70 for pinching it open as best seen in FIG. 9, to allow and cable strap 14 to be raised and lowered along the securing unit track and then released so the set of teeth 72 engage the toothed structure 69.

Considering now the cable strap 14 in greater detail, the cable strap 14 is elongate and is dimensioned to be received between the cable strap storage unit 32 and the cable strap securing unit 34. To help facilitate easy in positioning the cable strap 14 between the storage unit 32 and the securing unit 34, the cable strap 14 is provided with a pair of spaced apart flange members indicated generally at 74 and 76 respectively. The flange members are disposed at opposite ends of a support bar 78 and are configured to be in sliding engagement with the front walls 46, 60 of the cable strap storage unit 32 and the cable strap securing unit 34 respectively. In this regard, the flange members 74 and 76 allow the cable strap 14 to easily and freely move or glide up and down the cable support mechanism between the storage unit 32 and the securing unit 34.

The support bar 78 has an upper surface 80 and a lower surface 82 which surfaces are smooth with slightly upturned ends. In use the lower or under surface of the support bar 78 can be brought into engagement with a group of cables supported from below by the cable saddle unit 30 without presenting the cables with any sharp edges or surfaces. In a like manner, the upper or top surface 80 is sufficiently wide and sufficiently smooth and rounded to support from below another group of cables, such as the cable group 2A as best seen in FIG. 8. From the foregoing, it should be understood by those skilled in the art, that when plural straps are disposed between the cable strap storage unit 32 and the cable strap securing unit 34, more than two groups of cables may be supported and separated within the cable support mechanism 10.

Considering now the pinch lock 70 in greater detail with reference to FIGS. 9-10, the pinch lock 70 includes two finger engageable surfaces, an upper finger engagable surface 91 and a lower finger engageable surface 92. These surfaces are concave to allow them to be easily pinched together by a user grasping the bottom surface with his or her thumb and the upper surface with his or her index finger as best seen in FIG. 9.

When the user so grasps the pinch lock 70, the pinch lock 70 may be slightly rotated in a counter clockwise direction to cause the set of teeth 72 disposed on the pinch lock 70 to be disengaged from the toothed structure 68 of the securing unit 34. In this manner, the user may then raise or lower the entire cable strap 14 by raising or lower his or her hand relative to the cable support mechanism 10. In summary then, the pinch lock 70 is a finger engagable pawl body that facilitates moving a pair of movable pawls into locking engagement with the corresponding pair of spaced apart integrally formed toothed bar wall members disposed on opposite sides of the front wall slot, i.e. the toothed structure 68.

Considering now the method of using the cable support mechanism 10 in greater detail with reference to FIGS. 1-4 and 9, a user first grasps the clip 16 bending its upper leg 20 and its lower legs 22 towards each other to form a lateral notch for receiving either a drop wire, such as the drop wire 4 or a drop rod, such as the drop rod 6. The drop wire 4 is then positioned in the lateral notch. When so positioned, the user releases the legs 20, 22 allowing them to return to their normal positions so that the edges of the notches (24, 26) cut into or bite into the drop wire allowing the cable support mechanism 10 to be supported thereon.

Next, the user positions a group of cable on the cable saddle unit 30, allowing the cables to be supported within the cable support mechanism 10.

Next, as best seen in FIG. 2, which is illustrated without the supported cables or drop wire or drop rod support for sake of easy in explaining the operation of the cable support mechanism 10, the user reaches with his thumb and index finger into the top opening of the cable support unit 32 so that he or she can grasps the pinch lock 70 therebetween. When the pinch lock 70 has been securely grasped, the user raises the cable strap 14 upwardly a sufficient distance to allow the cable strap 14 to rotate laterally in a clockwise direction so that the flange member 74 is positioned in engagement with the front wall 46 of the storage unit 32 as best seen in FIG. 3.

Next, as best seen in FIG. 4, which again is illustrated without the drop wire support, the user continues the clockwise rotation of the cable strap 14 so that the other flange member 76 is positioned in engagement with the front wall 60 of the cable securing unit 34. In this position, the user is able to rotate the pinch lock 70 in a counter clockwise direction to raise and lower the cable strap 14 between the cable storage unit 32 and the cable securing unit 34 to a desired locking position, such as the locking position as best seen in FIG. 4. When the cable strap 14 is properly positioned, so that the lower surface 82 of the cable strap 14 is brought into near engagement with the cables supported from below on the cable saddle unit, the user releases the pinch lock 70 allowing the set of teeth 72 on the cable strap 14 to engage with the toothed structure 69 of the cable securing unit 34 which simultaneously secures the cables between the upper surface of the cable saddle 30 and the lower surface of the cable strap 14.

Next, if another group of cables is to be supported within the cable support mechanism 10, the user repeats the above-mentioned steps with the exception of allowing the next group of cables to be supported from below by the cable strap 14. In this regard, the next group of cable is support between a pair of cable straps as best seen in FIGS. 8-9.

Referring now to the drawings and more particularly to FIG. 11, there is illustrated a cable support mechanism kit 110, which is constructed in accordance with another preferred embodiment of the present invention. The kit 110 generally includes at least one body member 12 having a U-shape for housing at least one cable strap 14 when such cable strap 14 is not in use, and for facilitating the securing of said cable strap 14 in a fixed temporarily locked position when in use for cable retaining and separating purposes. As best seen in FIG. 11 the kit 110 includes a plurality of extra cable straps, each of which is identical in structure to cable strap 14. In this regard, in use once a cable strap has been secured in use in the body member 12, another cable strap may be introduced into the body member 12 and positioned for supporting from below another group of cables as best seen in FIG. 8. In addition to supporting a group of cables from below the kit 110 enables a group of cables to be cinched tightly together between a pair of cable straps, such as cable straps 14. This is an important feature of the present invention since it allows a user to securely mount a group of cables at fixed points (where each body member 12 is installed) in tightly bundled group eliminating cable slack that might otherwise be found in other types of mounting arrangements. From the foregoing, it should be understood by those skilled in the art, that the cable support mechanism kit 110 is adapted to enable a user to support in separate bundled groups a plurality of wire or cable bundles. Since the various elements and parts of the cable support mechanism kit 110 are identical to the cable support mechanism 10, except for the quantity of cable straps provided, the cable support mechanism kit 110 will not be described hereinafter in greater detail.

In summary then, the cable support mechanism 10 and cable support mechanism kit 10 enable groups of cables to be supported at a fixed point or in the alternative between fixed points by employing one or more of the cable support mechanisms. In this regard, it should be understood that when two or more of the cable support mechanisms 10 are employed, cables may be mounted therebetween without significant cable slack by pushing or ratcheting the cable strap 14 downwardly with sufficient force tightly against a group of cables disposed below the cable strap 14 to hold or cinch the group of cables sufficiently tightly together in a taunt relationship as they extended between individual cable support mechanisms 10 to substantially prevent cable slippage between supporting mechanism. Cables positioned and disposed within the individual cable support mechanisms are therefore able to be bundled together, supported from below and held or cinched tightly together in a fast and convenient manner by utilizing one of more of the cable straps, such as the cable strap 14.

It is noted that the preferred embodiments of the present invention described herein in detail for exemplary purposes is of course subject to many different variations in structure, design, application and methodology. Because many varying and different embodiments may be made within the scope of the inventive concept(s) herein taught, and because many modifications may be made in the embodiments herein detailed in accordance with the description requirements of the law, it is to be understood that the details herein are to be interpreted as illustrative and not in a limiting sense.

I claim:

1. A cable support mechanism, comprising:
a body member having a unitary construction including an elongate storage unit leg for housing at least one cable strap when such cable strap is not in use, an elongate cable strap securing unit leg for facilitating the positioning and securing of said cable strap in a temporarily locked position when such strap is in use for electrical conductor retaining and separating purposes, and an elongate cable saddle unit leg for supporting from below one or more electrical conductors within the cable support mechanism.

2. The cable support mechanism according to claim 1, further comprising:
a retaining clip mounted to said elongate storage unit;
wherein said retaining clip includes a set of notch cutouts to facilitate mounting the cable support mechanism to a drop wire.

3. The cable support mechanism according to claim 2, wherein retaining clip includes another set of notch cutouts to facilitate mounting the cable support mechanism to a drop rod.

4. The cable support mechanism according to claim 1, wherein said elongate storage unit is a hollow body member having:
an elongate rear wall portion;
a pair of elongate side wall portions;
an elongate front wall portion, wherein said elongate front wall portion has a slot extending substantially its entire longitudinal length for receiving and guiding therein said at least one cable strap; and
wherein said pair of elongate side wall portions each includes a cable strap track for engaging a proximal end portion of said at least one cable strap.

5. The cable support mechanism according to claim 4, wherein said elongate securing unit is a plural wall structure having:
another pair of elongate side wall portions;
an another elongate front wall portion, wherein said another elongate front wall portion has another slot extending substantially its entire longitudinal length for receiving and guiding therein said at least one cable strap; and
wherein said slot is a toothed structure for facilitating removably locking said cable strap in a locked position between said cable storage unit and said cable securing unit.

6. The cable support mechanism according to claim 1, wherein said cable storage unit has a sufficient volume for storing therein at least another cable strap.

7. The cable support mechanism according to claim 1, wherein said cable strap is an elongate support bar for supporting from below at least one cable,

8. A cable support mechanism kit, comprising:
at least one cable support mechanism, said cable support mechanism including a strap storage unit for storing at least one cable strap and for receiving for immediate use at least one other cable strap and a cable securing unit for facilitating vertical sliding of individual ones of a plurality of cable straps between said storage unit and said securing unit and for removably locking individual ones of said plurality of cable straps between said cable strap storage unit and said cable strap securing unit.

9. The cable support mechanism kit according to claim 8, wherein said cable strap storage unit includes an internally disposed retaining member for capturing said plurality of cable straps within said storage unit and for allowing vertical sliding of individual ones of said plurality of cable straps within said storage unit; and
wherein each individual one of said plurality of cable straps includes a pinch lock for engaging a toothed structure forming part of said cable securing unit to facilitate removably locking individual ones of said plurality of cable straps between said cable strap storage unit and said cable strap securing unit.

10. The cable support mechanism kit according to claim 9, wherein each individual one of said plurality of cable straps includes a pinch lock for engaging a toothed structure forming part of said cable securing unit to facilitate removably locking individual ones of said plurality of cable straps between said cable strap storage unit and said cable strap securing unit.
wherein said cable strap storage unit has an internally disposed retaining member for capturing said plurality of cable straps within said storage unit and for allowing vertical sliding of individual ones of said plurality of cable straps within said storage unit;
wherein said cable securing unit facilitates the vertical sliding of individual ones of said plurality of cable straps between said storage unit and said securing unit and for removably locking individual ones of said plurality of cable straps between said cable strap storage unit and said cable strap securing unit.

11. The cable support mechanism kit according to claim 8, wherein said at least one cable support mechanism includes a hollow cable holder having a base leg member disposed between two upright straight leg members;
wherein one of said upright straight leg members has an elongated cutout for defining a pair of spaced apart integrally formed toothed bar wall members;
wherein another one of said upright straight leg members has another elongated cutout disposed in parallel alignment with said elongated cutout for cooperating with said elongated cutout to define a cable strap path between said upright straight leg members;
wherein said another one of said upright straight leg members has a pair of spaced apart integrally formed retaining slots;
a cable strap slidably mounted between said retaining slots within said another one of said upright straight leg members;
wherein said cable strap is adapted to be stored within said another one of said straight leg members when not in use clamping a cable;
wherein said cable strap is further adapted to be pulled upwardly a sufficient distance from within said another one of said straight leg members to enable said cable strap to be pivotally turned and extended to be received within said elongated cutout for rectilinear movement along said cable strap path; and
wherein said cable strap has disposed on its distal end a pair of movable pawls for engaging said pair of spaced apart integrally formed toothed bar wall members for selectively locking said cable strap within said cable strap path to facilitate clamping a cable between said cable strap and said base leg member.

12. The cable support mechanism kit according to claim 11, wherein said pair of spaced apart integrally formed retaining slots terminate at about an upper end of said another one of said upright straight leg members to form a stop to substantially prevent said cable strap from escaping from said another one of said upright straight leg members and for defining a pivot point for pivotally turning said cable strap in order to extend said cable strap to be received within said elongated cutout for rectilinear movement along said cable strap path.

13. The cable support mechanism kit according to claim 12, wherein said cable strap includes:
an elongated guide having a sufficient length dimension to be received slidably between said retaining slots;
an elongated hollow body member having a sufficient length dimension to be received between the two upright straight leg members and a sufficient width dimension to prevent said body member from passing through said pair of spaced apart integrally formed toothed bar wall members; and
a finger engagable pawl body for facilitating moving said pair of movable pawls into locking engagement with said pair of spaced apart integrally formed toothed bar wall members.

14. A cable strap adapted for use in a cable support mechanism, said cable support mechanism having a unitary construction including two upright straight leg members disposed on opposite sides of a U-shaped leg member, wherein one of the two upright straight leg member is a storage unit for the cable strap and wherein the other straight leg member cooperates with the first mentioned straight leg member to facilitate a rectilinear sliding action by the cable strap between the two upright straight leg members until the cable strap is in a user selected temporarily locked position therebetween, the cable strap comprising:
a support bar for supporting from below at least one cable;
a pair of flange member disposed opposite from one another at opposite ends of said support part;
a pair of elongate stem member slightly spaced from an individual one of said pair of flange member; and
a finger engagable pinch lock having a set of teeth disposed slightly spaced from the other one of said pair of flange members; and
wherein said set of teeth are adapted to be slightly rotated in a direction away from its adjacent flange member.

15. The cable strap according to claim 14, wherein said support bar has an upper surface and a lower surface which surfaces are smooth;
wherein said support bar has slightly upturned end portions.

16. The cable strap according to claim 15, wherein said upper surface is sufficiently wide and sufficiently smooth and rounded to support from below a group of cables.

17. The cable strap according to claim 16, wherein said pinch lock includes two finger engagable surfaces that includes an upper finger engagable surface and a lower finger engagable surface.

18. The cable strap according to claim 17, wherein said pinch lock may be slightly rotated in a counter clockwise direction.

19. The cable support mechanism according to claim 7, wherein said cable strap further includes:
a pair of flange member disposed opposite from one another at opposite ends of said support part;
a pair of elongate stem member slightly spaced from an individual one of said pair of flange member; and
a finger engagable pinch lock having a set of teeth disposed slightly spaced from the other one of said pair of flange members; and
wherein said set of teeth are adapted to be slightly rotated in a direction away from its adjacent flange member.

20. The cable support mechanism kit according to claim 8, further comprising:
at least another cable support mechanism, wherein said another cable support mechanism including another strap storage unit for storing at least another cable strap and for receiving for immediate use at least another cable strap and a cable securing unit for facilitating vertical sliding of individual ones of a plurality of cable straps between said storage unit and said securing unit and for removably locking individual ones of said plurality of cable straps between said cable strap storage unit and said cable strap securing unit; and
wherein said at least one cable support mechanism and said at least another cable support mechanism and their associated cable straps cooperate to substantially eliminate cable slack between said at least one cable support mechanism and said at least another cable support mechanism by pushing the individual cable straps downwardly with sufficient force to cinch a group of cables sufficiently tightly together within the respective ones of the cable support mechanism to substantially prevent cable slippage between them.
